(19) United States
(12) Patent Application Publication
(10) Pub. No.: US 2026/0045135 A1
(43) Pub. Date: Feb. 12, 2026

(54) METHOD FOR A GAMING SYSTEM

(71) Applicant: Play'n Go Marks Ltd, Valletta (MT)

(72) Inventors: Charlotte MILIZIANO, Valletta (MT); Peter DOMBI, Valletta (MT)

(73) Assignee: Play'n Go Marks Ltd, Valletta (MT)

(21) Appl. No.: 19/360,233

(22) Filed: Oct. 16, 2025

Related U.S. Application Data
(63) Continuation-in-part of application No. 17/475,468, filed on Sep. 15, 2021.

(30) Foreign Application Priority Data
Sep. 17, 2020 (SE) 2051085-5

(51) Int. Cl. G07F 17/32; G07F 17/34

(52) U.S. Cl. CPC G07F 17/3211; G07F 17/3225; G07F 17/34

(57) ABSTRACT

The present disclosure relates to a computer implemented method performed by a gaming system. In particular, the present disclosure relates to a scheme for further improving a randomness in a game provided by means of the gaming system. The present disclosure also relates to a corresponding gaming system and a computer program product.

### CROSS-REFERENCE TO RELATED APPLICATIONS

This application is a continuation-in-part of U.S. patent application Ser. No. 17/475,468, filed on Sep. 15, 2021, which claims priority to Swedish Patent Application No. 2051085-5, filed on Sep. 17, 2020. The disclosure of each of the above applications is incorporated herein by reference in its entirety.

### TECHNICAL FIELD

The present disclosure relates to a computer implemented method performed by a gaming system. In particular, the present disclosure relates to a scheme for further improving a randomness in a game provided by means of the gaming system. The present disclosure also relates to a corresponding gaming system and to a computer program product.

### BACKGROUND

Games of chance are known and widely played for recreational purposes. The gaming industry has come to recognize that to sustain long term success it must be constantly innovative in introducing new games and new gaming concepts to the gaming public. One example of this innovating drive can be appreciated in the embrace of the Internet and online gaming by the gaming industry.

A common trend within the online gaming industry is to provide potentially new and current players with new means for attracting and ensuring that players remain at the online site, controlled by a gaming operator, providing the games. An example of such a means is the introduction of further unexpected scenarios in the game, potentially allowing a player to be further driven to play the game since the player has a desire to participate with the game in case of such an unexpected scenario appearing.

The introduction of possible unexpected scenarios in the game could also further increase the payout to the player, since the unexpected scenario possibly could add a further leverage to a bet placed by the player. Although this of course is of high interest to the player, such further possible payouts must be closely controlled by a gaming operator, ensuring that the payouts stay within desired boundaries. Thus, there is a general need to balance the attraction power of the game by means of possible further and higher payouts, while at the same time ensuring that an operator is in total control of the game.

### SUMMARY

According to an aspect of the present disclosure, the above is at least partly met by computer implemented method performed by a gaming system adapted to execute a series of consecutive games, the gaming system comprising a server arranged in communication with an electronic user device using a network connection, the series of consecutive games comprising a plurality of individual games played at the electronic user device, the electronic user device comprising a display screen configured to display a graphical user interface (GUI), wherein the method comprises forming, at the server, an initial table having predetermined dimensions and comprising a corresponding number of cells, generating, at the server, a first set of elements corresponding to the cells of the initial table, each generated element being one of a plurality of predefined element types including a generic type, and the first set of elements comprises at least one generic type element, populating, at the server, the cells of the initial table with the first set of elements, wherein each cell includes a single element of the first set of elements, directing, using the server, the electronic user device to render a graphical representation of the initial table within the GUI displayed on the display screen, identifying, at the server, a cluster of cells of the initial table that is populated with matching elements, determining, at the server, a first gaming outcome by applying a predefined matching scheme to match the identified cluster with a plurality of predefined cluster formations, forming, using the server, an updated table based on the initial table and the first gaming outcome, the updated table including one or more changed elements, generating, at the server, a meta-data object representative of the updated table by comparing the updated table with the initial table to identify the one or more changed elements, the meta-data object encoding positional and symbolic attributes of the one or more changed elements of the updated table, transmitting only the meta-data object from the server to the electronic user device, directing, using the server, the electronic user device to render an updated graphical representation of the updated table within the GUI displayed on the display screen based on the meta-data object, wherein the generic type element remains within the same cell for a predetermined lifetime spanning over at least two of the plurality of individual games of the series of consecutive games, the generic type element comprises a multiplication factor, the multiplication factor adapted to influence the first gaming outcome and being dependent on a present position within its lifetime such that the multiplication factor changes for each game in the series of consecutive games, the predetermined lifetime has a beginning and an end, and the generic type element is removed at the end of the predetermined lifetime

In accordance to the present disclosure, at least a portion of the gaming concept where the player is interacting involves engaging with a table comprising a plurality of cells, where the cells are arranged in lines and columns and where each of the cells is populated with at least one element. Such elements may for example include different types of elements, for example including numbers and/or symbols of any kind and matching a desired implementation of the game to be played by the player.

According to the present disclosure, if the server identifies that the elements of the tables are arranged in such a manner that a predetermined number of adjacent cells comprise matching elements, then this identified “cluster of elements” are matched with a plurality of predefined cluster formations. In case a match is found, the server determines a first gaming outcome. In some embodiments at least five cells must comprise matching elements. It may however be possible to set this number both higher and lower and still stay within the boundaries of the present disclosure.

Possibly, a cluster may be determined as “identified” if e.g. at least a predetermined number of cells comprising matching elements are located adjacently to each other. The predetermined number of cells may for example be five, however this predefined number may also be lower or higher. The definition of “adjacently” may be dependent on the specific implementation of the present scheme. For example, adjacently may be defined as arranged on the same row of the table or in the same column of the table. It may however also be possible to allow other cluster formations to be seen as adjacently, such for example comprising a combination of cells arranged both on different columns and on different rows, but at least sharing a side of a cell to another cell holding a matching element. Other definitions of clusters comprising matching elements are of course possible and within the scope of the present disclosure. Such a further example of a cluster may be where matching elements form specific “shapes”, but not necessarily share a cell side with each other. Thus, two adjacent cells may possibly, in some embodiments, be seen as two cells at least having “touching” cell corners.

For ensuring that the matching is performed with a minimum amount of perceived delay in the progression of the game it is desirable to apply a computational efficient predefined matching scheme. Possible schemes that can be used in relation to the present disclosure include different forms of feature detection algorithms that today find usage within e.g. the computer vision field, such as for detecting and describing local features in images. In some embodiments of the present disclosure the predefined matching scheme may be selected to apply e.g. feature descriptors or feature vectors, where the plurality of predefined cluster formations are expressions of such feature descriptors or feature vectors. Other predefined matching schemes are also possible and within the scope of the present disclosure.

In some embodiments, the plurality of predefined cluster formations generates different gaming outcomes, where potentially in comparison more “complex” clusters comprising specifically “unusual” elements may generate a different gaming outcome as compared to a less complex cluster comprising “common” elements.

Generally, when the operational scheme according to the present disclosure is applied to a game concept provided by the server, it may be possible to further increase the randomization of the game, as compared to prior-art, by the introduction of the generic type element and its related multiplication factor, thus potentially allowing for increasing winning possibilities for a player participating in the game. An advantage following such a possibility is an improved attraction power to the game, thus potentially allowing for the player to remain playing the game for an increased duration as compared to previously known similar operational schemes. This could potentially be beneficial to both the player participating in the game and the gaming operator providing the game.

Within the context of the present disclosure it should be understood that the generic element type, in some embodiments defined as a wild card or a joker element, may be matchable to all of the plurality of predefined element types. As such, the generic element type may be equally matchable with e.g. a number as well as a symbol.

As defined by the present control scheme, the generic type element will remain within the same specific cell of the table for a predefined lifetime of the generic type element. That is, in some embodiment of the present disclosure the other elements populating the table will typically change every game of the series of consecutive games, whereas the generic type element will stay present. However, as the generic type element generally has a limited lifetime, it will remain for its defined lifetime and then be replaced with a new element (that again could be a generic type element or any other of the types of elements).

In addition to the above, the generic type element will include the above-mentioned multiplication factor, where the multiplication factor will be adjusted throughout the lifetime of the generic type element. Generally, the multiplication factor will remain the same for one game and then be changed for the next game.

The combination of the limited lifetime and the multiplication factor will possibly increase the overall gain for the player in playing the games, as well as promoting the player to continue playing the game when the table comprises at least one generic type element. It should of course be understood that some games of the series of consecutive games have tables populated with elements not being of the generic type. Rather, the generic type element could in some embodiments be introduced in a semi or fully randomized manner, meaning that the player again would be promoted to remain playing the game for a prolonged time, with the hope that a generic type element will appear.

The limited lifetime of the generic type element will furthermore ensure that the operator of the gaming system will have a limited risk when a generic type element is present, since the generic type element will only remain “sticky” for a finite duration. Thus, the total possible playout to the player will be limited in a corresponding manner. Seen in total, the limited lifetime of the generic type element will thus possibly generate an increased payout to the player, increase the attractiveness of the game, promote the player to continue playing the game, while at the same time balancing the risk for the operator of the gaming system.

In certain embodiments, the server implements a data-efficient communication mechanism for updating the graphical representation of the game table on the electronic user device. Instead of transmitting an entire table image or complete table state after each individual game, the server identifies only those elements of the table that have changed relative to a previously rendered table and forms a meta-data object describing the changes. The meta-data object may encode, for each changed element, positional attributes (for example, the cell coordinates) and symbolic attributes (for example, the type, visual appearance, multiplier value, or removal flag) that enable the user device to reconstruct the updated table locally.

Transmitting only the meta-data object can significantly reduce the volume of data exchanged between the server and the electronic user device. As a result, network bandwidth usage can be reduced and the end-to-end latency between a gaming outcome being determined at the server and the corresponding update being displayed at the user device can be shortened. The reduction in latency allows the system to maintain a real-time feel even in fast-changing games involving consecutive gaming rounds.

Furthermore, since the electronic user device receives only semantic change data, it can select a rendering technique best suited to its hardware and graphical capabilities, thereby achieving smoother animations and lower power consumption. The solution as defined above may also improve scalability of the gaming platform, allowing the same server resources to support a larger number of concurrent users and associated user devices while maintaining consistent update performance.

In a preferred embodiment of the present disclosure the multiplication factor is decreasing for each consecutive game over the predetermined lifetime. Possibly, the multiplication factor may for example decrease in integer steps from one game to the next game in the series of consecutive games. For example, the multiplication factor can have a predefined range, such as between one to 10, preferably one to five and most preferably one to three.

In an exemplary implementation, where the multiplication factor is decreasing for each consecutive game, the multiplication factor may start at three and then decrease stepwise from three to two and then to one over three consecutive games. The multiplication factor for the generic type element may as such influence the first gaming outcome (relating to a first game in the series of consecutive games) with time 3 (×3), followed by ×2 for a second gaming outcome (relating to a second game in the series of consecutive games), followed by ×1 for a third gaming outcome (relating to a third game in the series of consecutive games). The lifetime will in this embodiment be directly related to when the multiplication factor equals zero, meaning that the generic type element at this stage will “disappear” from the table (to be replaced with any type of element for the next consecutive game in the series of games).

It should of course be understood that the multiplication factor possibly may increase for each consecutive game over the predetermined lifetime. In such an implementation the multiplication factor could for example start with ×1 for the first game, followed by ×2 for the second game, etc. The limited lifetime will in the end control an upper endpoint for the multiplication factor, after which the generic type element will disappear from the table, in a similar manner as discussed above.

In some embodiment of the present disclosure, it may be possible to adapt the gaming system to operate a main game and a bonus game, where the generic type element is only formed during a bonus game. Accordingly, the operator of the gaming system may be provided with even further control of when and where the generic type element is to be introduced. This also allows the operator to in a swift way control how to “drive” players to play specific (main) games, where the main games are provided with related bonus games. The bonus games may for example include a free spin, a respin, or both (when the game relates to a slot game).

In addition to the above, it may be possible to allow the predetermined lifetime of the generic type element to be dependent on the length of a game, the length of the bonus game, a generic type element being present on the table, or a combination of the three. Such embodiments may even further allow for operator controllability of the gaming system.

In some embodiments of the present disclosure the series of consecutive games are games of chance, such as for example including a slot game, where the player is placing a bet to be allowed to participate in the game (or series of games). The gaming outcome may in such an embodiment be dependent on the bet placed by the player.

The concept according to the present disclosure may however be applied to other types of games, including e.g. sports bet or similar, where the gaming outcome generated by means of the present scheme may be used for e.g. allowing the player to increase a total outcome generated by e.g. a sports bet.

As indicated above, the server is in charge of controlling the electronic user device to display the table as well as the gaming outcome at the display screen of the electronic user device. In some embodiments the electronic user device is adapted to present a graphical user interface (GUI) at the display screen. The server may in a corresponding manner be adapted to a graphical representation of at least one of the table, the gaming outcome and the updated table, to be distributed to the electronic user device, where the graphical representation is then presented within the GUI.

Such a GUI may also be arranged to allow the player to directly interact with the server, for example allowing the player to control his/her participation in the game as well as to control a size of the bet placed when participating in the game.

Within the context of the present disclosure the expression “forming a graphical representation” should be interpreted broadly. Specifically, it should be understood that the server in some embodiment may be configured to only form a collection of “meta-data” (here corresponding to the graphical representation) that will be rendered at the frontend, such as within the GUI of the electronic user device. However, in another embodiment it may be the other way around, meaning that the server will essentially form an image (here corresponding to the graphical representation) that then will be displayed within the GUI of the electronic user device. Further alternative implementations along the same mutations are possible and within the scope of the present disclosure. Additionally, it may also be possible to allow the graphical representation to be set differently for different game operators, players or groups of players. The graphical representation may also be dependent on e.g. the geographical location of the players, such as dependent on city, country or continent where the player is located/registered.

Within the context of the present disclosure it should be understood that in some embodiments it may be possible to allow the server to control if a specific electronic user device is to be allowed to apply the scheme according to the present disclosure. Such control may for example be dependent on a geographical location of the electronic user device. Possibly, the geographical location may be selected from a group comprising a city, a country and a continent.

According to another aspect of the present disclosure there is provided a gaming system comprising a server adapted to execute a series of consecutive games, the gaming system arranged in communication with an electronic user device using a network connection, the series of consecutive games comprising a plurality of individual games played at the electronic user device, the electronic user device comprising a display screen configured to display a graphical user interface (GUI), wherein the server is adapted to form an initial table having predetermined dimensions and comprising a corresponding number of cells, generate a first set of elements corresponding to the cells of the initial table, each generated element being one of a plurality of predefined element types including a generic type, and the first set of elements comprises at least one generic type element, populate the cells of the initial table with the first set of elements, wherein each cell includes a single element of the first set of elements, direct the electronic user device to render a graphical representation of the initial table within the GUI displayed on the display screen, identify a cluster of cells of the initial table that is populated with matching elements, determine a first gaming outcome by applying a predefined matching scheme to match the identified cluster with a plurality of predefined cluster formations, form an updated table based on the initial table and the first gaming outcome, the updated table including one or more changed elements, generate a meta-data object representative of the updated table by comparing the updated table with the initial table to identify the one or more changed elements, the meta-data object encoding positional and symbolic attributes of the one or more changed elements of the updated table, transmit only the meta-data object to the electronic user device, direct the electronic user device to render an updated graphical representation of the updated table within the GUI displayed on the display screen based on the meta-data object, wherein the generic type element remains within the same cell for a predetermined lifetime spanning over at least two of the plurality of individual games of the series of consecutive games, the generic type element comprises a multiplication factor, the multiplication factor adapted to influence the first gaming outcome and being dependent on a present position within its lifetime such that the multiplication factor changes for each game in the series of consecutive games, the predetermined lifetime has a beginning and an end, and the generic type element is removed at the end of the predetermined lifetime. This aspect of the present disclosure provides similar advantages and embodiments as discussed above in relation to the previous aspects of the present disclosure.

Preferably, the gaming system is a cloud-based computing system and the server is a cloud server. Thus, the computing power provided by means of the invention may be distributed between a plurality of servers, and the location of the servers must not be explicitly defined. Advantageous following the use of a cloud-based solution is also the inherent redundancy achieved.

In some embodiments the electronic user devices may be selected to include e.g. a computer (laptop/stationary), a mobile phone, a tablet, a (gaming) consoles or any other gaming device and gambling terminals. The GUI may in some embodiments be allowed to depend on the type of electronic user device.

According to a still further aspect of the present disclosure there is provided a computer program product comprising a non-transitory computer readable medium having stored thereon a computer program for operating a gaming system, the gaming system arranged in communication with an electronic user device using a network connection, the series of consecutive games comprising a plurality of individual games played at the electronic user device, the electronic user device comprising a display screen configured to display a graphical user interface (GUI), the computer program product comprising code for forming, at the server, an initial table having predetermined dimensions and comprising a corresponding number of cells, code for generating, at the server, a first set of elements corresponding to the cells of the initial table, each generated element being one of a plurality of predefined element types including a generic type, and the first set of elements comprises at least one generic type element, code for populating, at the server, the cells of the initial table with the first set of elements, wherein each cell includes a single element of the first set of elements, code for directing, using the server, the electronic user device to render a graphical representation of the initial table within the GUI displayed on the display screen, code for identifying, at the server, a cluster of cells of the initial table that is populated with matching elements, code for determining, at the server, a first gaming outcome by applying a predefined matching scheme to match the identified cluster with a plurality of predefined cluster formations, code for forming, using the server, an updated table based on the initial table and the first gaming outcome, the updated table including one or more changed elements, code for generating, at the server, a meta-data object representative of the updated table by comparing the updated table with the initial table to identify the one or more changed elements, the meta-data object encoding positional and symbolic attributes of the one or more changed elements of the updated table, code for transmitting only the meta-data object from the server to the electronic user device, code for directing, using the server, the electronic user device to render an updated graphical representation of the updated table within the GUI displayed on the display screen based on the meta-data object, wherein the generic type element remains within the same cell for a predetermined lifetime spanning over at least two of the plurality of individual games of the series of consecutive games, the generic type element comprises a multiplication factor, the multiplication factor adapted to influence the first gaming outcome and being dependent on a present position within its lifetime such that the multiplication factor changes for each game in the series of consecutive games, the predetermined lifetime has a beginning and an end, and the generic type element is removed at the end of the predetermined lifetime. Also this aspect of the present disclosure provides similar advantages and embodiments as discussed above in relation to the previous aspects of the present disclosure.

The computer program product is typically executed using a computing device comprised with the server, preferably including a microprocessor or any other type of computing device. Similarly, a software executed by the server for operating the gaming system may be stored on a computer readable medium, being any type of memory device, including one of a removable nonvolatile random access memory, a hard disk drive, a floppy disk, a CD-ROM, a DVD-ROM, a USB memory, an SD memory card, or a similar computer readable medium known in the art. Accordingly, operation of the gaming system may be at least partly automated, implemented as e.g. software, hardware and a combination thereof.

Further features of, and advantages with, the present disclosure will become apparent when studying the appended claims and the following description. The skilled addressee should realize that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 illustrates an exemplary gaming system according to a currently preferred embodiment of the present disclosure,

FIG. 2 provides an exemplary illustration of a typical graphical user interface (GUI) for use in playing a game,

FIGS. 3A-3C present exemplary illustrations of operations of different tables according to different embodiments of the present disclosure, and

FIG. 4 is a flow chart illustrating the exemplary steps for operating the gaming system as shown in FIG. 1.

### DETAILED DESCRIPTION

The present disclosure will now be described more fully hereinafter with reference to the accompanying drawings, in which currently preferred embodiments of the present disclosure are shown. This present disclosure may, however, be embodied in many different forms and should not be construed as limited to the embodiments set forth herein; rather, these embodiments are provided for thoroughness and completeness to fully convey the scope of the present disclosure to the skilled addressee. Like reference characters refer to like elements throughout.

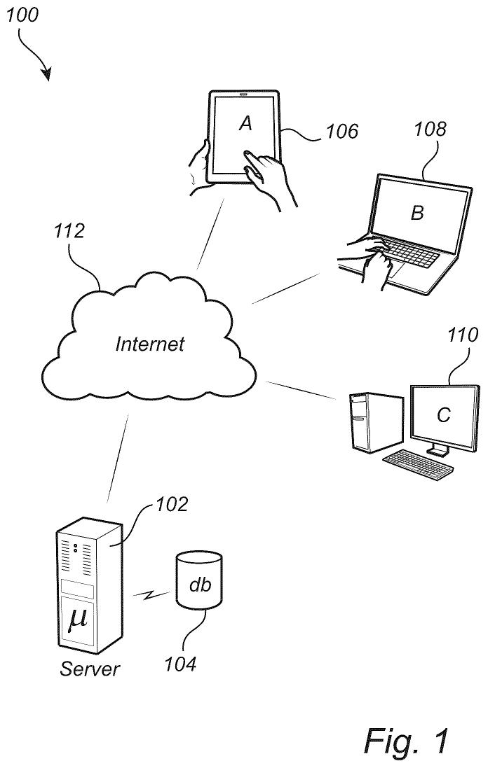

Referring now to the drawings and FIG. 1 in particular, there is depicted a gaming system 100 in which an online game, such as a slot game, may be played according to a currently preferred embodiment of the present disclosure. The system architecture illustrated in FIG. 1 depicts a system environment in which systems, methods, apparatus, computer-readable mediums and data structures consistent with the principles of some embodiments of the present disclosure may be included. It may be appreciated that the components of system 100 may be implemented through any suitable combinations of hardware, software, and/or firmware.

As shown in FIG. 1, system 100 includes at least one server 102 and/or at least one gaming database 104. Server 102 and gaming database 104 may be communicably linked to a plurality of electronic user devices in the form of electronic user devices, such as client devices 106, 108, 110, etc. through network 112. The network 112 may be wired or wireless, including for example wired connections like a building LAN, a WAN, an Ethernet network, an IP network, etc., and wireless connections like WLAN, CDMA, GSM, GPRS, 3G mobile communications, 4G mobile communications, Bluetooth, infrared, or similar. As such, the network 112 may be locally and/or globally provided.

The gaming database 104 may be any type of physical unit on which games reside, such as a machine in a gaming venue, a lottery machine, an electronic game system, etc. Network 112 may be implemented as the Internet, or any local or wide area network, either public or private. Network 112 may also be a hardware system physically connecting some or all of the server 102 and client devices 106, 108, 110. Client devices 106, 108, 110, typically each operated by a player, may be implemented as any computing devices such as a personal computing device, a server, a server network, handheld computing device, slot machine, other gaming machine in a gaming venue such as a betting terminal, a gaming console, lottery machine, an interface in a virtual environment, etc.

It may be appreciated by one of ordinary skill in the art that while only one server, one gaming database, one network and two client devices are depicted, more or fewer servers, more or fewer gaming databases, more networks and more or fewer client devices and/or other devices may reside within system 100.

The elements inside system 100 may include one or more (micro) processors, purpose-built hardware such as, for example, FPGA, ASIC, etc., software systems and applications, software packages, mechanical and electrical parts, etc. Software packages that may be part of server 102, gaming database 104, client devices 106, 108, 110 and network 112 may be recorded on a computer readable medium such as a memory device, RAM, CD/DVD/USB drives, handheld memory device, etc., and/or may be part of a physical device such as one or more (microprocessors or electro-mechanical systems. Any of server 102, gaming database 104, client devices 106, 108, 110, network 112 and further electronic user device 114 may be fixed systems, mobile systems, portable systems, or cloud systems (as discussed above). FIG. 1 shows only three electronic user devices 106, 108, 110, however it should be understood that a general implementation of the present disclosure comprises a large plurality of electronic user devices, possibly greatly above three, such as 100, 1000, 10000, etc.

Although the various components of FIG. 1 are illustrated as discrete elements, it should be recognized that certain operations of some of the various components may be performed by the same physical device, e.g., by one or more microprocessors or other type of devices.

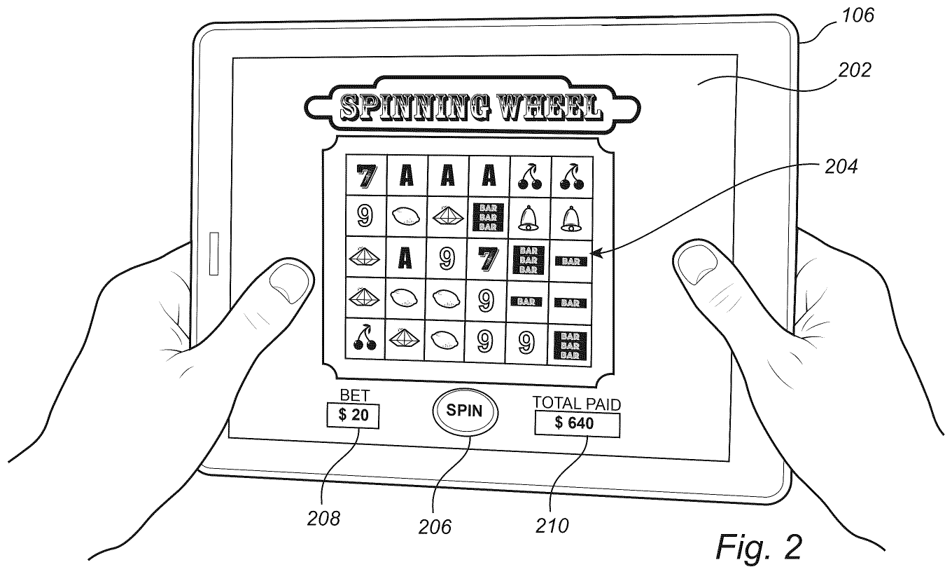

Turning now to FIG. 2 illustrating a graphical user interface (GUI) 202 to be displayed at a client device, such as any of the client devices 106, 108, 110, in the illustrated embodiment provided as an application (“app”) or within e.g. a web browser of the portable client device 106 being a tablet. The game to be played at the client device 106 is here shown as an online game of chance in the form of a slot game, visualized within the GUI 202 as comprising a table comprising six individual reels 204 arranged in columns and provided with a plurality of different symbols. The table also comprises five rows. As such, the predefined dimension of the table as shown in FIG. 2 is six times five, thus comprising 30 cells in total.

The GUI also comprises a “button” 206 to start the game, here provided with the description “SPIN” for initiating a turn of the game. In addition, the GUI 202 comprises an indicator of the current bet 208 (i.e. payment for each turn of the game) and an indicator of the total payment to the player 210. It should in any case be understood that other types of games may be played within the scope of the present disclosure, for example being skill based as compared to a game of chance.

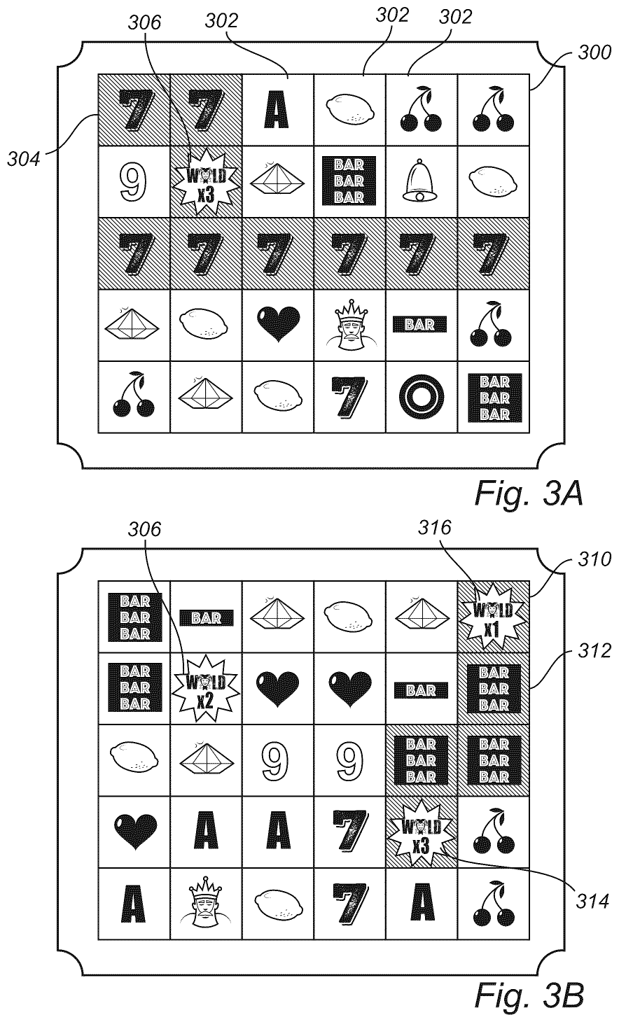

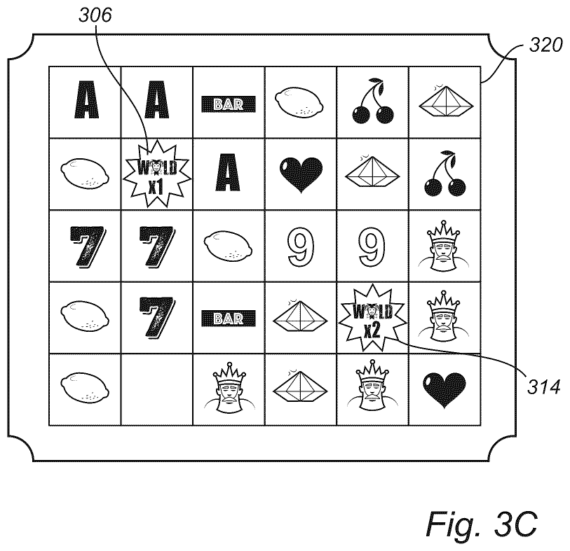

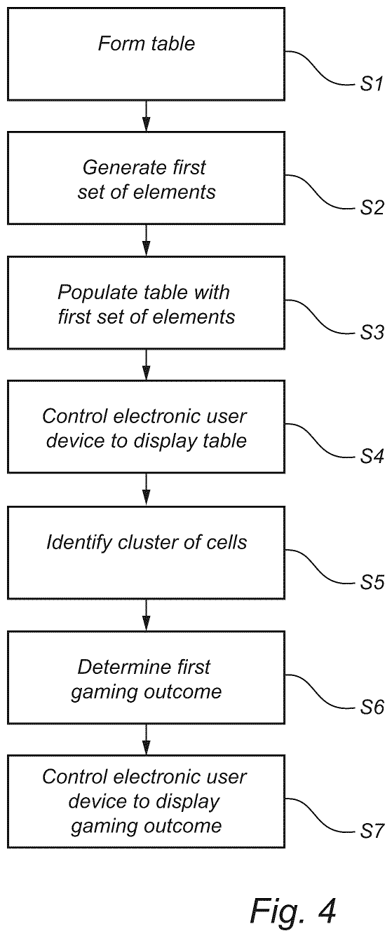

Turning now to FIGS. 3A-3C in conjunction with FIG. 4, illustrating different tables according to different embodiments of the present disclosure. In FIG. 3A there is first shown an initial table 300 comprising a plurality of cells 302 arranged in rows and columns, corresponding to the table as shown in FIG. 2, e.g. displayable at a display screen of any of the client devices 106, 108, 110.

As is exemplified in FIG. 3A, the server 102 has formed, S1, and then generated, S2, a first set of elements which have been arranged to populate, S3, the initial table 300. The server has then controlled, S4, the client device 106, for example, to display the populate table 300. In the case of a game of chance the elements may be at least semi-randomly generated and similarly the positioning of the elements within the table 300 may be semi-randomly selected. The first set of elements comprises a plurality of predefined elements types, in FIG. 3A, a cherry, a diamond, the number seven, a heart etc. and a first generic type element 306.

The generic type element may in some embodiments be defined as a ‘wild card’ or a ‘joker’ element. The generic type element will remain within the same cell of the table 300 for a predetermined life span and further comprises multiplication factors generated and assigned by the server 102. The multiplication factors assigned by the server 102 to the generic type element will either increase or decrease for each consecutive game over the life span of the generic type element until a multiplication threshold is reached. The life span of the generic type element is therefore linked to the multiplication factor generated and assigned by the server 102 in that once an upper or a lower threshold of the multiplication factor has been reached, the generic type element will be removed from the table 300. The multiplication factors generated and assigned to each generic type element may be randomly generated by the server 102 and fall within an upper and a lower threshold. In preferred embodiments the generic type element is matchable to each of a plurality of predefined element types.

In FIG. 3A, the first generic type element is a first joker 306 which comprises a first multiplication factor of three generated and assigned by the server 102.

When the initial table 300 is populated with the first set of elements, the server 102 performs an automated process of identifying, S5, a cluster 304 matching elements within the table 300. In FIG. 3A, the matching elements are shown as being the number ‘7’.

The definition of a cluster may be differing from game to game. In FIG. 3A, a cluster is identified in case at least a predefined number of elements are arranged adjacently to one another. In the embodiment of FIG. 3A, the cluster predefined number has been set to five. This predefined number may, however, be set higher or lower.

In case a cluster 304 has been identified, the server 102, then determines, S6, a first gaming outcome. The gaming outcome may in some embodiments be dependent on the elements comprised in the cluster. As such, a cluster comprising ‘unusual’ elements may generate a gaming outcome that is perceived by the player as more valuable/desirable as compared to a situation where the cluster comprises more ‘common’ elements. The operator of the game may be allowed to select what elements are to be considered as unusual and as common.

The first gaming outcome will further be enhanced by the fact that the joker 306 includes a multiplication factor of three, for example the first gaming outcome may be multiplied by a factor of three.

Once the server 102 has determined the first gaming outcome, the server will proceed to control, S7, the client device 106 to display the first gaming outcome. As such, the player will typically be informed within the display screen of the client device 106 what was ‘won’ due to the identification of the specific type of cluster of elements and multiplication factor of the joker 306.

In some embodiments, after the first gaming outcome has been determined, the server 102 will define an updated table reflecting the outcome, for example by removing, replacing or otherwise changing the elements that formed part of the identified cluster 304. Accordingly, the updated table will include one or more changed elements. The server 102 may then construct a data representation of the updated table and compare this representation with a data representation of a previously rendered table, such as the initial table for the same game or a table from a prior game in the series of consecutive games. Through such a comparison, the server 102 identifies which cells have changed (i.e., the one or more changed elements) and records, for each changed cell, at least one positional attribute (for example, the cell coordinates) and at least one symbolic attribute (for example, the new element type, multiplier value or state flag) of the one or more changed elements.

The server 102 forms a meta-data object comprising the identified attributes for the changed cells only. The meta-data object may further include optional fields such as a sequence identifier, timestamp, or checksum allowing the client device 106 to verify integrity and ordering of received updates. The server 102 transmits the meta-data object to the client device 106 in real-time rather than transmitting an entire image or complete table structure. The client device 106 then updates its locally stored table and renders only the changed cells within the graphical user interface, thereby producing a new graphical representation corresponding to the updated table.

By transmitting only the meta-data describing differences between successive table states, the amount of data exchanged between the server 102 and the client device 106 can be significantly reduced, which in turn can lower network load and latency. The arrangement allows smooth and responsive updating of the display even in fast-changing games and permits the client device 106 to select a rendering method appropriate to its hardware capabilities.

In FIG. 3B, a second consecutive table 310 of the game (in the series of games) is shown where the table 310 has been populated by the server 102 with a second set of elements. The second set of elements comprises a plurality of predefined elements types as in FIG. 3A, the first joker 306, a second joker 314 and a third joker 316. The multiplication factor of the first joker 306 has now decreased sequentially by a factor of one from the first multiplication factor generated and assigned by the server 102 to a multiplication factor of two. The second joker 314 comprises a multiplication factor of three and the third joker 316 comprises a multiplication factor of one.

When the table 310 is populated with the second set of elements, the server 102 performs an automated process of identifying a cluster 312 matching elements within the table 310. In FIG. 3B, the matching elements are shown as being ‘bars’. In case a cluster 312 has been identified, the server 102, then determines a second gaming outcome. The second gaming outcome will further be enhanced by the fact that three jokers each having different multiplication factors are included in the second gaming outcome.

In FIG. 3C, a third consecutive table 320 of the game (in the series of games) is shown where the table 320 has been populated by the server with a third set of elements. The third set of elements comprises a plurality of predefined elements types as in FIGS. 3A and 3B, the first joker 306 and the second joker 314. The multiplication factor of the first joker 306 has again decreased sequentially by a factor of one from the second multiplication factor generated and assigned by the server 102 to a multiplication factor of one. The multiplication factor of the second joker 314 has decreased sequentially by a factor of one from the first multiplication factor generated and assigned by the server to a multiplication factor of two. The third joker 316 has been removed from the table 320 as the multiplication threshold was reached i.e. the multiplication factor decreased sequentially from one to zero.

When the table 320 is populated with the third set of elements, the server 102 performs an automated process and determines a third gaming outcome. The third gaming outcome will further be enhanced by the fact that two jokers each having different multiplication factors are included in the third gaming outcome. Unfortunately for the player, in FIG. 3C no cluster is identified and thus the combined multiplication factor will have no impact to the end result for the table 320.

In summary, the present disclosure relates to a computer implemented method performed by a gaming system adapted to execute a series of consecutive games, the gaming system comprising a server arranged in communication with an electronic user device using a network connection, the electronic user device comprising a display screen, wherein the method comprises the forming, at the server, a table having a predetermined dimension and comprising a corresponding number of cells, generating, at the server, a first set of elements corresponding to the cells of the table, each generated element being one of a plurality of predefined element types including a generic type, and the first set of elements comprises a generic type element, populating, at the server, the cells of the table with the first set of elements, directing, using the server, the electronic user device to display the table at the display screen, identifying, at the server, a cluster of cells of the table being populated with matching elements, determining, at the server, a first gaming outcome by applying a predefined matching scheme to match the identified cluster with a plurality of predefined cluster formations, directing, using the server, the electronic user device to display the gaming outcome at the display screen, wherein the generic type element remains within the same cell for a predetermined lifetime spanning over at least a portion of the series of consecutive games, and the generated generic type element comprises a multiplication factor, the multiplication factor adapted to influence the first gaming outcome and being dependent on a present position within its lifetime.

Generally, when the operational scheme according to the present disclosure is applied to a game concept provided by the server, it may be possible to increase the randomization of the game by the introduction of the generic type element and its related multiplication factor, thus potentially allowing for increasing winning possibilities for a player participating in the game. An advantage following such a possibility is an improved attraction power to the game, thus potentially allowing for the player to remain playing the game for an increased duration as compared to previously known similar operational schemes. This could potentially be beneficial to both the player participating in the game and the gaming operator providing the game.

In addition, the control functionality of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures may show a sequence the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps. Additionally, even though the present disclosure has been described with reference to specific exemplifying embodiments thereof, many different alterations, modifications and the like will become apparent for those skilled in the art. Further, a single unit may perform the functions of several means recited in the claims. In the claims, any reference signs placed between parentheses shall not be construed as limiting to the claim. Furthermore, in the claims, the word “comprising” does not exclude other elements or steps, and the indefinite article “a” or “an” does not exclude a plurality.

Variations to the disclosed embodiments can be understood and effected by the skilled addressee in practicing the claimed present disclosure, from a study of the drawings, the disclosure, and the appended claims. The person skilled in the art realizes that the present disclosure is not limited to the preferred embodiments.

What is claimed is:

1. A computer implemented method performed by a gaming system adapted to execute a series of consecutive games, the gaming system comprising a server arranged in communication with an electronic user device using a network connection, the series of consecutive games comprising a plurality of individual games played at the electronic user device, the electronic user device comprising a display screen configured to display a graphical user interface (GUI), the method comprising:
forming, at the server, an initial table having predetermined dimensions and comprising a corresponding number of cells,
generating, at the server, a first set of elements corresponding to the cells of the initial table, each generated element being one of a plurality of predefined element types including a generic type, and the first set of elements comprises at least one generic type element,
populating, at the server, the cells of the initial table with the first set of elements, wherein each cell includes a single element of the first set of elements,
directing, using the server, the electronic user device to render a graphical representation of the initial table within the GUI displayed on the display screen,
identifying, at the server, a cluster of cells of the initial table that is populated with matching elements,
determining, at the server, a first gaming outcome by applying a predefined matching scheme to match the identified cluster with a plurality of predefined cluster formations,
forming, using the server, an updated table based on the initial table and the first gaming outcome, the updated table including one or more changed elements,
generating, at the server, a meta-data object representative of the updated table by comparing the updated table with the initial table to identify the one or more changed elements, the meta-data object encoding positional and symbolic attributes of the one or more changed elements of the updated table,
transmitting only the meta-data object from the server to the electronic user device,
directing, using the server, the electronic user device to render an updated graphical representation of the updated table within the GUI displayed on the display screen based on the meta-data object,
wherein:
the generic type element remains within the same cell for a predetermined lifetime spanning over at least two of the plurality of individual games of the series of consecutive games,
the generic type element comprises a multiplication factor, the multiplication factor adapted to influence the first gaming outcome and being dependent on a present position within its lifetime such that the multiplication factor changes for each game in the series of consecutive games,
the predetermined lifetime has a beginning and an end, and
the generic type element is removed at the end of the predetermined lifetime.

2. The method according to claim 1, wherein the generic type element is matchable to each of the plurality of predefined element types.

3. The method according to claim 1, wherein the multiplication factor is decreasing for each consecutive game over the predetermined lifetime.

4. The method according to claim 1, wherein the multiplication factor is increasing for each consecutive game over the predetermined lifetime.

5. The method according to claim 1, wherein:
the gaming system is adapted to operate a main game and a bonus game, and
the generic type element is only formed during the bonus game.

6. The method according to claim 5, wherein the bonus game includes a free spin, a respin, or both.

7. The method according to claim 1, wherein the predetermined lifetime of the generic type element is dependent on a length of a game, a length of a bonus game, a generic type element being present in the table, or a combination of the three.

8. The method according to claim 1, wherein the multiplication factor has a predefined range.

9. The method according to claim 8, wherein the predefined range is between 1 to 10.

10. The method according to claim 1, further comprising:
receiving, at the server, a bet from the electronic user device,
wherein the determination of the first gaming outcome is further dependent on the bet.

11. The method according to claim 1, wherein at least one of the predetermined dimensions of the table and the predefined element types are selected based on a type of game being executed at the server.

12. A gaming system comprising a server adapted to execute a series of consecutive games, the gaming system arranged in communication with an electronic user device using a network connection, the series of consecutive games comprising a plurality of individual games played at the electronic user device, the electronic user device comprising a display screen configured to display a graphical user interface (GUI), wherein the server is adapted to:
form an initial table having predetermined dimensions and comprising a corresponding number of cells,
generate a first set of elements corresponding to the cells of the initial table, each generated element being one of a plurality of predefined element types including a generic type, and the first set of elements comprises at least one generic type element,
populate the cells of the initial table with the first set of elements, wherein each cell includes a single element of the first set of elements,
direct the electronic user device to render a graphical representation of the initial table within the GUI displayed on the display screen,
identify a cluster of cells of the initial table that is populated with matching elements,
determine a first gaming outcome by applying a predefined matching scheme to match the identified cluster with a plurality of predefined cluster formations,
form an updated table based on the initial table and the first gaming outcome, the updated table including one or more changed elements,
generate a meta-data object representative of the updated table by comparing the updated table with the initial table to identify the one or more changed elements, the meta-data object encoding positional and symbolic attributes of the one or more changed elements of the updated table,
transmit only the meta-data object to the electronic user device,
direct the electronic user device to render an updated graphical representation of the updated table within the GUI displayed on the display screen based on the meta-data object,
wherein:
the generic type element remains within the same cell for a predetermined lifetime spanning over at least two of the plurality of individual games of the series of consecutive games,
the generic type element comprises a multiplication factor, the multiplication factor adapted to influence the first gaming outcome and being dependent on a present position within its lifetime such that the multiplication factor changes for each game in the series of consecutive games,
the predetermined lifetime has a beginning and an end, and
the generic type element is removed at the end of the predetermined lifetime.

13. The gaming system according to claim 12, wherein the generic type element is matchable to each of the plurality of predefined element types.

14. The gaming system according to claim 12, wherein the server is further adapted to decrease the multiplication factor for each consecutive game over the predetermined lifetime.

15. The gaming system according to claim 12, wherein the server is further adapted to increase the multiplication factor for each consecutive game over the predetermined lifetime.

16. The method according to claim 12, wherein:
the gaming system is adapted to operate a main game and a bonus game, and
the generic type element is only formed during the bonus game.

17. The gaming system according to claim 12, wherein the server is further adapted to:
receive a bet from the electronic user device,
wherein the determination of the first gaming outcome further dependent on the bet.

18. The gaming system according to claim 12, wherein the multiplication factor has a predefined range.

19. The gaming system according to claim 12, wherein the predefined range is between 1 to 10.

20. A computer program product comprising a non-transitory computer readable medium having stored thereon a computer program for operating a gaming system, the gaming system arranged in communication with an electronic user device using a network connection, the series of consecutive games comprising a plurality of individual games played at the electronic user device, the electronic user device comprising a display screen configured to display a graphical user interface (GUI), the computer program product comprising:
code for forming, at the server, an initial table having predetermined dimensions and comprising a corresponding number of cells,
code for generating, at the server, a first set of elements corresponding to the cells of the initial table, each generated element being one of a plurality of predefined element types including a generic type, and the first set of elements comprises at least one generic type element,
code for populating, at the server, the cells of the initial table with the first set of elements, wherein each cell includes a single element of the first set of elements,
code for directing, using the server, the electronic user device to render a graphical representation of the initial table within the GUI displayed on the display screen,
code for identifying, at the server, a cluster of cells of the initial table that is populated with matching elements,
code for determining, at the server, a first gaming outcome by applying a predefined matching scheme to match the identified cluster with a plurality of predefined cluster formations,
code for forming, using the server, an updated table based on the initial table and the first gaming outcome, the updated table including one or more changed elements,
code for generating, at the server, a meta-data object representative of the updated table by comparing the updated table with the initial table to identify the one or more changed elements, the meta-data object encoding positional and symbolic attributes of the one or more changed elements of the updated table,
code for transmitting only the meta-data object from the server to the electronic user device,
code for directing, using the server, the electronic user device to render an updated graphical representation of the updated table within the GUI displayed on the display screen based on the meta-data object,
wherein:
the generic type element remains within the same cell for a predetermined lifetime spanning over at least two of the plurality of individual games of the series of consecutive games,
the generic type element comprises a multiplication factor, the multiplication factor adapted to influence the first gaming outcome and being dependent on a present position within its lifetime such that the multiplication factor changes for each game in the series of consecutive games,
the predetermined lifetime has a beginning and an end, and
the generic type element is removed at the end of the predetermined lifetime.
